(19) United States
(12) Patent Application Publication
(10) Pub. No.: US 2026/0301001 A1
(43) Pub. Date: Oct. 1, 2026

(54) Telemetry Tracking Based on Custom Endpoints

(71) Applicant: Bank of America Corporation, Charlotte, NC (US)

(72) Inventors: Steven E. Sinks, Scottsdale, AZ (US); Joshua Abraham, Sharon, MA (US)

(21) Appl. No.: 19/090,543

(22) Filed: Mar. 26, 2025

(51) Int. Cl. G06Q 30/0201; G06F 16/245

(52) U.S. Cl. CPC G06Q 30/0201; G06F 16/245

(57) ABSTRACT

Arrangements for capturing, correlating and analyzing telemetry data from endpoints are provided. In some examples, a computing platform may receive a request to access a resource. In response, the platform may generate a unique endpoint that includes a uniform resource identifier and may be based on the resource and characteristics of a user device. The platform may transmit the endpoint to the user device and may receive an indication of user selection of the endpoint. The platform may direct the user device to the requested resource and capture telemetry data related to interactions between the user device and the resource. The platform may receive, from an enterprise computing device, a query requesting the telemetry data related to the interactions between the user computing device and the resource. The platform may generate a query response including the telemetry data and may transmit, to the enterprise computing device, the query response.

### BACKGROUND

Aspects of the disclosure relate to electrical computers, systems, and devices for capturing user telemetry data on endpoints.

Understanding the activities and preferences of customers of an enterprise organization is key to providing a satisfying customer experience. In order to provide a positive experience for customers, understanding end-user activities at various endpoints may be beneficial. However, conventional systems for capturing telemetry about end-user activities on endpoints does not provide the robust information needed to fully understand customer activities, preferences and objectives. For instance, conventional arrangements for capturing telemetry data rely on scripting or log file analysis that do not provide sufficient capabilities to collect, correlate and analyze the data. Accordingly, it would be advantageous to provide a more robust solution for capturing telemetry data at endpoints and analyzing the data to provide high level and granular inputs to customer preferences.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with capturing, correlating and analyzing telemetry data from endpoints.

In some examples, a computing platform having at least one processor and memory may receive or intercept a request to access a resource. The request may be received from a user computing device. In some examples, in response to receiving the request, the computing platform may generate a unique endpoint that includes a uniform resource identifier (URI). The unique endpoint may be based on the resource and characteristics of the user device, such as an internet protocol (IP) address.

The computing platform may transmit or send the unique endpoint to the user computing device which may cause the user computing device to display the unique endpoint. The computing platform may receive an indication of user selection of the unique endpoint which may cause the computing platform to direct the user computing device to the requested resource and may enable capture of telemetry data related to user interactions between the user computing device and the resource. The computing platform may store the telemetry data.

In some arrangements, the computing platform may receive, from an enterprise organization computing device, such as an administrator or other device, a query requesting the telemetry data related to, at least, the user interactions between the user computing device and the resource. The computing platform may generate a query response including at least the telemetry data related to the user interactions between the user computing device and the resource and may transmit, to the enterprise organization computing device, the query response. In some examples, transmitting the query response may cause the query response to be displayed by a display of the enterprise organization computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for telemetry tracking based on custom endpoints in accordance with one or more aspects described herein;

FIGS. 2A-2C depict an illustrative event sequence for telemetry tracking based on custom endpoints in accordance with one or more aspects described herein;

FIG. 3 illustrates an illustrative method for telemetry tracking based on custom endpoints according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, capturing, correlating and analyzing user telemetry data can be a challenge for enterprise organizations. The arrangements described herein provide a system for providing conditional responses (e.g., hypertext transfer protocol (HTTP) responses) based on conditional requirements that can be generated and built by a user via a user interface (e.g., via a JSON application programming interface (API) or dynamically using machine learning.

As discussed more fully herein, the arrangements described provide for generation of customized or unique endpoints (uniform resource identifiers (URIs)) that provide the ability to provide conditional based responses. For instance, a different or particular response (e.g., HTTP response) may be provided to a user requesting a resource. The customized or unique endpoints may enable an enterprise organization to track not only who is accessing a webpage but also workflows within a website, application or the like, interactions of the user, applications themselves, and the like. For instance, telemetry tokens may be generated and used to provide information related to browser information, device information, device operating system, geographic location, internet protocol (IP) address, time of day, and the like. The captured telemetry data may be stored. One or more queries requesting telemetry data may be received by the system and telemetry data meeting the conditions or parameters of a query may be provided. For instance, a request for telemetry data related to users within 50 miles of a particular city may be received and telemetry data meeting those conditions may be returned to the requesting device. The data provided may be for one or more particular users, groups of users, all users meeting the conditions, or the like. Accordingly, both high level trends and more granular data may be provided and used to improve the customer experience.

These and various other arrangements will be discussed more fully below.

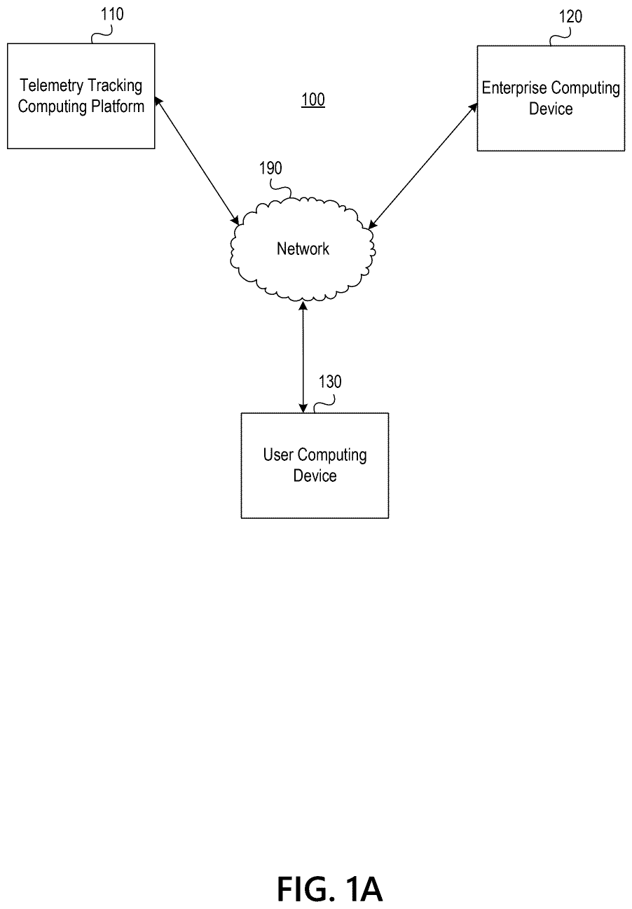

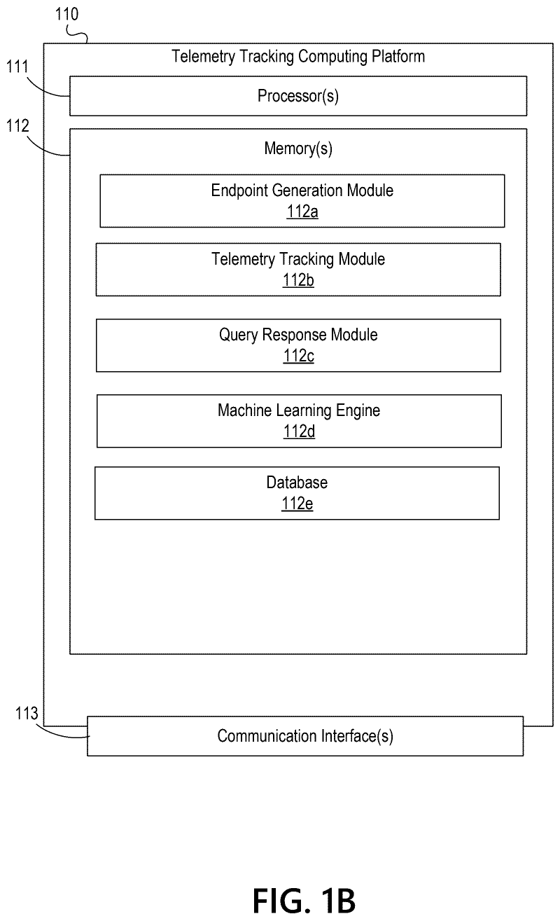

FIGS. 1A-1B depict an illustrative computing environment and devices for telemetry data tracking in accordance with one or more aspects described herein. Referring to FIG. 1A, computing environment 100 may include one or more computing devices and/or other computing systems. For example, computing environment 100 may include telemetry tracking computing platform 110, enterprise computing device 120, and user computing device 130.

Although one enterprise computing device 120 and one user computing device 130 are shown, any number of systems or devices may be used without departing from the invention.

Telemetry tracking computing platform 110 may be or include one or more computer components (e.g., servers, server blade, processor, memory, and the like) and may be configured to perform intelligent, dynamic, real-time generation of unique endpoints to enable telemetry data capture. For instance, telemetry tracking computing platform 110 may receive, from a user computing device, such as user computing device 130, a request to access a resource (e.g., website, application, or the like). In response to the request, telemetry tracking computing platform 110 may capture data related to the user computing device 130 and generate a unique endpoint for the user to access the resource. The unique endpoint may be a static string of characters (e.g., /login, or the like) or may be a dynamically generated string of, in some examples, random characters. In some arrangements, machine learning may be used to generate the dynamically generated random string of characters. The unique endpoint may be based on the requested resource, as well as characteristics or attributes of the user or user computing device 130 (e.g., geo location data determined from, for instance, an IP address, or the like).

Telemetry tracking computing platform 110 may transmit or send the unique endpoint to the user computing device 130 which may cause the user computing device 130 to display the unique endpoint. The user may select the unique endpoint, causing the user to be directed to the resource and/or providing a particular response to the user (e.g., HTTP response), and telemetry tracking computing platform 110 may receive notification of the selection, as well as telemetry data captured during the user interaction with the resource (e.g., web pages viewed, selections made, issues encountered, or the like). Telemetry tracking computing platform 110 may store the telemetry data.

Telemetry tracking computing platform 110 may receive, from an administrator or other enterprise device, such as enterprise computing device 120, a query. In some examples, the query may include a request for the telemetry data captured during the user interaction with the resource. The request may include a request for telemetry data for a particular user, group of users, application, website, or the like. In some examples, the request may include a request based on autonomous system number (ASN), classless inter-domain routing (CIDR), geographic location (e.g., based on IP address), or the like. Telemetry tracking computing platform 110 may retrieve the stored telemetry data and compile a query response based on one or more conditions (e.g., location, or the like). Telemetry tracking computing platform 110 may transmit or send the query response to the enterprise computing device 120, which may cause the enterprise computing device 120 to display the query response, telemetry data, and the like.

Enterprise computing device 120 may be or include one or more computer components (e.g., servers, server blade, processor, memory) and/or computing devices (e.g., laptop computers, desktop computers, mobile devices, tablet devices, or the like) and may be configured to generate queries requesting telemetry data, trends in telemetry data, ongoing or frequent issues, and the like. Enterprise computing device 120 may further be configured to display query response/telemetry data, user interfaces including trend information, current status information, and the like.

User computing device 130 may be or include one or more computing devices (e.g., laptop computers, desktop computers, mobile devices, tablet devices, or the like) that may be used by a user or customer to initiate a request to access a resource, receive and display a unique or custom endpoint, select the unique or custom endpoint and interact with the requested resource. User computing device 130 may transmit or send, based on selection of the unique endpoint, telemetry data associated with the user, user device, interactions with the resource, and the like, to the telemetry tracking computing platform 110.

As mentioned above, computing environment 100 also may include one or more networks, which may interconnect one or more of telemetry tracking computing platform 110, enterprise computing device 120, and/or user computing device 130. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, telemetry tracking computing platform 110, enterprise computing device 120, and/or user computing device 130 may be connected via network 190.

Referring to FIG. 1B, telemetry tracking computing platform 110 may include one or more processors 111, memory 112, and communication interface 113. A data bus may interconnect processor(s) 111, memory 112, and communication interface 113. Communication interface 113 may be a network interface configured to support communication between telemetry tracking computing platform 110 and one or more networks (e.g., network 190, or the like). Memory 112 may include one or more program modules having instructions that when executed by processor(s) 111 cause telemetry tracking computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of telemetry tracking computing platform 110 and/or by different computing devices that may form and/or otherwise make up telemetry tracking computing platform 110.

For example, memory 112 may have, store and/or include endpoint generation module 112a. Endpoint generation module 112a may store instructions and/or data that may cause or enable telemetry tracking computing platform 110 to generate one or more unique or custom endpoints or URIs in response to a user request to access a resource. For instance, telemetry tracking computing platform 110 may receive an indication of a user request to access a resource and may capture data related to the request (e.g., user computing device IP address, or the like). Based on the IP address, telemetry tracking computing platform 110 may identify a geographic location of the user computing device and may generate a unique or custom endpoint associated with the requested resource. The unique or custom endpoint may further be generated based on the user, user computing device characteristics, IP address, and/or identified geographic location. In some examples, a plurality of unique endpoints may be generated for a particular user and used within a website, application, or the like, such that selection of any of the unique endpoints generates or enables capture of telemetry data related to an associated feature, aspect, or the like.

In some examples, endpoint generation module 112a may generate a static custom endpoint that may include a fixed string of characters. In some examples, the static custom endpoint may be reusable by one or more users. In some examples, the static custom or unique endpoint may be generated (e.g., via a web interface) using an application programming interface (API) via a JSON based interface. Additionally or alternatively, the endpoint generation module 112a may dynamically generate a custom or unique endpoint that may, in some examples, include a random string of characters. In some arrangements, machine learning may be used to dynamically generate the unique or custom endpoint. For instance, the requested resource and/or user data, user device data, IP address, geographic location, or the like, may be input to the machine learning model. Upon execution of the machine learning model, the model may output a dynamically generated unique endpoint. The endpoint generation module 112a may transmit or send the unique endpoint to the user computing device 130.

In some arrangements, the generated endpoints provide the ability to perform conditional based requirements. For instance, a particular unique endpoint may provide a particular response to a user requesting access to a resource. For instance, a file-based telemetry endpoint may provide different or particular files based on certain criteria. Additionally or alternatively, responses such as HTTP status code 200 (e.g., request successfully received), 404 (e.g., resource not found), 302 (e.g., redirect), and/or a combination of those responses may be provided. In some examples, a remote file include response may be provided that may retrieve data from another website and provide it seamlessly to the users.

Telemetry tracking computing platform 110 may further have, store and/or include telemetry tracking module 112b. Telemetry tracking module 112b may store instructions and/or data that may cause or enable the telemetry tracking computing platform 110 to receive and track telemetry data based on user selection of a unique endpoint and interaction with a resource (e.g., user interaction with a web page, issues with an application, internet service issues, and the like). In some examples, telemetry tracking module 112b may store further instructions to generate and transmit one or more alerts upon detecting a triggering event. For instance, one or more users (e.g., administrative users or other enterprise organization users) may request an alert or notification when certain types of telemetry data are detected, when a particular error or type of error is detected, when a particular region, area or service provided is impacted, or the like. Various other alerts may be used without departing from the invention. In some examples, the alerts or notifications may be logged in a database or other data storage structure for further investigation.

Telemetry tracking computing platform 110 may further have, store and/or include query response module 112c. Query response module 112c may store instructions and/or data that may cause or enable the telemetry tracking computing platform 110 to receive a query requesting telemetry data for one or more users, groups of users, geographic locations, applications, or the like. Query response module 112c may retrieve the requested telemetry data (e.g., as captured by the telemetry tracking module 112b) and generate query response data that may be transmitted to a requesting device. Query response module 112c may generate one or more user interfaces, dashboards, or other graphic representations of the telemetry data in addition to or instead of generating and providing the telemetry data itself.

Telemetry tracking computing platform 110 may further have, store, and/or include machine learning engine 112d. Machine learning engine 112d may store instructions and/or data that may cause or enable the telemetry tracking computing platform 110 to train, execute, update and/or validate one or more machine learning models. For instance, machine learning engine 112d may train one or more machine learning models to identify correlations, sequences or patterns in data in order to output, for instance, a unique endpoint based on user data, device data, IP address, or the like. In some examples, historical data related to users, user computing devices, geographic locations, and/or one or more resources may be used to train the one or more models to establish stored correlations. The machine learning engine 112d may use these stored correlations to analyze subsequent user data, and the like, to generate the unique endpoint.

In some examples, machine learning engine 112d may further train, execute, update and/or validate the machine learning model to analyze received telemetry data to output one or more insights, issues, alerts, or the like. For instance, historical data related to user actions or interactions, workflows, applications, issues and the like, may be used to train the machine learning model to identify correlations, sequences or patterns in subsequent data. Accordingly, telemetry data received by the telemetry tracking computing platform 110 may, in some examples, be input to the machine learning model and, upon execution of the machine learning model, one or more issues, alerts, or the like, may be output by the machine learning model. In some arrangements, the machine learning model may output trends, actionable items, or the like, which may be used to identify a remediation action (e.g., communication with a provider or other third party, or the like).

Telemetry tracking computing platform 110 may further have, store and/or include database 112e. Database 112e may store data related to resources (e.g., web pages, applications, and the like), user computing devices, geographic data, IP addresses, captured telemetry data and/or any other data to perform the functions of telemetry tracking computing platform 110.

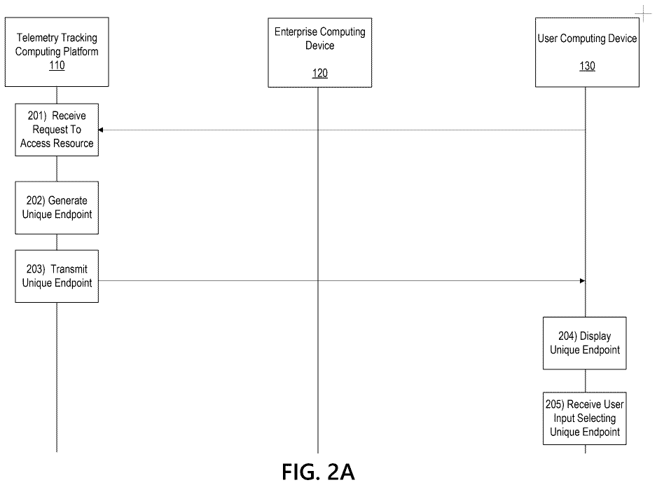

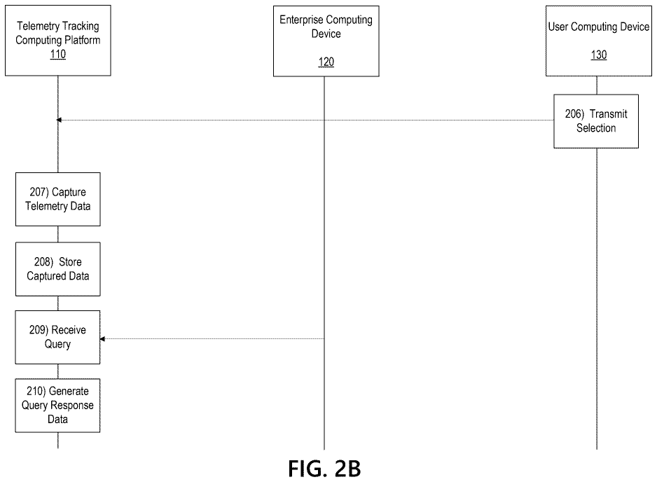

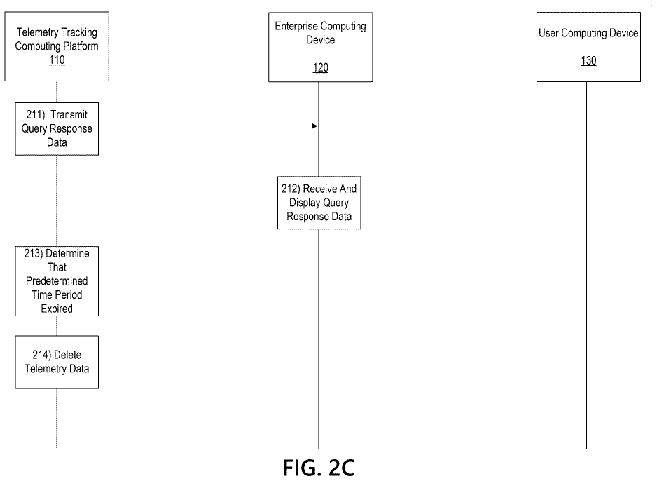

FIGS. 2A-2C depict one example illustrative event sequence for telemetry tracking via custom endpoints in accordance with one or more aspects described herein. The events shown in the illustrative event sequence are merely one example sequence and additional events may be added, or events may be omitted, without departing from the invention. Further, one or more processes discussed with respect to FIGS. 2A-2C may be performed in real-time or near real-time.

With reference to FIG. 2A, at step 201, telemetry tracking computing platform 110 may receive a request to access a resource. For instance, user computing device 130 may receive, from a user, a request to access a webpage, application, or the like. Telemetry tracking computing platform 110 may receive or intercept the request to access the resource. Telemetry tracking computing platform 110 may retrieve, from the request, request information. In some examples, request information may include an IP address associated with user computing device 130, user information, and the like. In some examples, a geographic API interface may be used to extract, from the request to access the resource, the IP address of the user computing device 130 and, based on geographic lookup information, identify a geographic region of the user computing device 130.

At step 202, telemetry tracking computing platform 110 may generate a unique or custom endpoint enabling capture of telemetry data during the session between the user computing device 130 and the resource. For instance, based on the resource requested and data associated with the user computing device 130 (e.g., IP address or the like), a unique or custom endpoint associated with the resource may be generated. In some examples, the IP address associated with user computing device 130 may be used to identify a geographic location of the user computing device 130 and the unique endpoint may be generated based on the geographic location of the user computing device 130. Various other conditional responses may be generated without departing from the invention. The custom or unique endpoint may be or include a uniform resource identifier (URI) associated with the resource but configured to enable capture of telemetry data by the telemetry tracking computing platform 110.

In some examples, the unique endpoint may be a static string of characters for use by the user and/or by one or more other users (e.g., users in a same geographic area). Additionally or alternatively, the unique endpoint may be dynamically generated and may include a random string of characters. In some examples, the dynamically generated unique endpoint may be generated using machine learning. For instance, a machine learning model trained to receive, as inputs, user device data, resource information, and the like, may output, based on stored correlations, patterns or sequences, a dynamically generated unique endpoint.

In some examples, the machine learning model may be trained using historical data related resources, user devices, and the like. In some examples, training the machine learning model may include using one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 203, telemetry tracking computing platform 110 may transmit or send the unique endpoint to the user computing device 130. In some examples, transmitting or sending the unique endpoint to user computing device 130 may cause the unique endpoint to display on a display of the user computing device (e.g., for selection by the user).

At step 204, user computing device 130 may receive and display the unique endpoint.

At step 205, user computing device 130 may receive user input selecting the unique endpoint.

With reference to FIG. 2B, at step 206, user computing device 130 may transmit or send the selection of the unique endpoint. In some examples, selection of the unique endpoint may direct the user computing device 130 to the requested resource and enable telemetry tracking computing platform 110 to capture telemetry data associated with a session between the user computing device 130 and the resource. For instance, selections made, sites visited, issues encountered, and the like, may be captured during the session. This data may then be used to identify issues, remediate issues, understand user preferences, and the like.

At step 207, telemetry tracking computing platform 110 may capture telemetry data during the session between the user computing device 130 and the resource. For instance, data related to the service provider used by the user computing device 130, access to the resource, work flows during the session with the resource, any issues or errors in access or working within the resource, and the like, may be captured by the telemetry tracking computing platform 110.

At step 208, telemetry tracking computing platform 110 may store the captured telemetry data. In some examples, the data may be stored for a predetermined period of time (e.g., one day, one week, one month, six months, one year, or the like) and may be automatically deleted upon expiration of the period. The enterprise may customize the period of time for storage of data. For instance, smaller enterprises having fewer resources may choose to store data for a shorter time period than larger enterprises having greater resources. In some examples, some types of telemetry data may be stored for a longer duration than other types.

At step 209, telemetry tracking computing platform 110 may receive a query from, for instance, enterprise computing device 120. The query may include a request for telemetry data. In some examples, the request may include a request for data associated with a particular user or user device, group of users or devices, geographic area, resource, issue, or the like.

At step 210, telemetry tracking computing platform 110 may generate query response data. For instance, telemetry tracking computing platform may extract, from stored telemetry data, data responsive to the query to generate query response data.

With reference to FIG. 2C, at step 211, telemetry tracking computing platform 110 may transmit or send the query response data to the enterprise computing device 120. In some examples, sending the query response data may cause the data to be displayed by a display of the enterprise computing device 120.

At step 212, enterprise computing device 120 may receive and display the query response data.

At step 213, telemetry tracking computing platform 110 may determine whether a predetermined time period for storing the telemetry data has expired. Responsive to determining that the predetermined time period has expired, at step 214, the telemetry tracking computing platform 110 may delete some or all of the stored telemetry data.

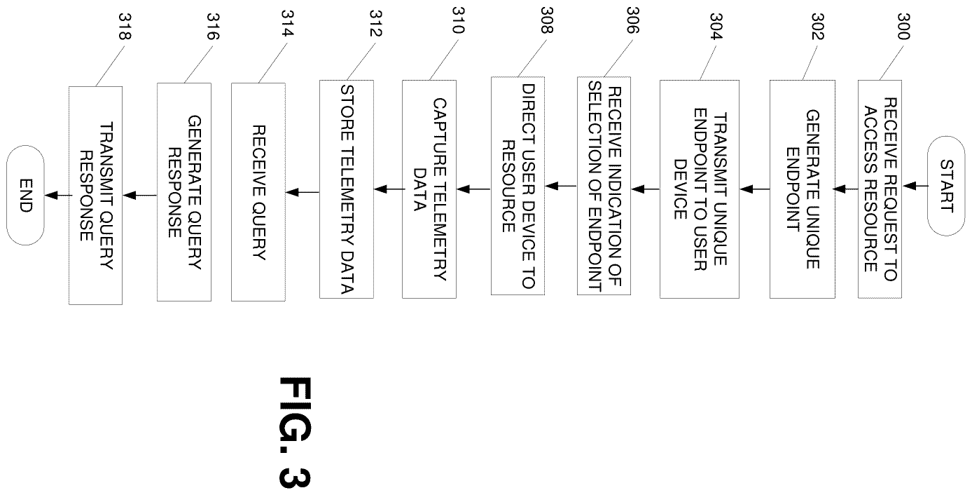

FIG. 3 is a flow chart illustrating one example method of capturing and tracking telemetry data in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, telemetry tracking computing platform 110 may receive a request to access a resource. For instance, telemetry tracking computing platform 110 may receive, from a user computing device 130, a request to access a resource, such as a website, application, or the like.

At step 302, telemetry tracking computing platform 110 may generate one or more unique endpoints. For instance, telemetry tracking computing platform may generate one or more unique endpoints including a URI and based on the request. For instance, the unique endpoint may be based on the resource, user information, user device information, or the like. In some examples, an API may be used to extract IP address information from the request and geographic information associated with the IP address may be identified and used to generate the unique endpoint.

As discussed herein, the unique endpoint may be a static endpoint or may be a dynamically generated endpoint. In some examples, machine learning may be used to dynamically generate the one or more unique endpoints.

At step 304, telemetry tracking computing platform 110 may transmit or send the unique endpoint to the requesting device (e.g., user computing device 130). In some examples, the unique endpoint may be transmitted as a selectable link, a button or other interface element, or the like. In some examples, the endpoint may be built into an application or website and provided to the user via the application or website.

At step 306, telemetry tracking computing platform 110 may receive an indication of selection of the endpoint. For instance, the user may select the link or other representation of the unique endpoint.

At step 308, telemetry tracking computing platform 110 may direct the user computing device 130 to the resource via the unique endpoint.

At step 310, based on user selection of the unique endpoint, telemetry data associated with the user, user interaction with the resource, user device, and the like, may be captured. In some examples, the telemetry data may be captured as the user interacts with the resource (e.g., through workflows, selections, and the like). A telemetry token may be generated for various actions taken by the user and transmitted to the telemetry tracking computing platform 110.

At step 312, telemetry tracking computing platform 110 may store the telemetry data. In some examples, the data may be stored for a predetermined time period that may be customizable by the enterprise organization implementing the system. For instance, upon determining that a predetermined time period has expired, the telemetry tracking computing platform 110 may automatically delete the stored telemetry data.

At step 314, telemetry tracking computing platform 110 may receive a query requesting the telemetry data. In some examples, the query may be received from an enterprise device, such as enterprise computing device 120.

At step 316, the telemetry tracking computing platform 110 may generate query response data. In some examples, the query response data may include the telemetry data captured during the requested session between the user computing device 130 and the resource. Additionally or alternatively, the query response data may include telemetry data from one or more other user sessions responsive to the query request or meeting the conditions of the query request.

At step 318, telemetry tracking computing platform 110 may transmit or send the query response data to the requesting computing device (e.g., enterprise computing device 120). In some examples, transmitting or sending the query response data may cause the query response data to be displayed by a display of the enterprise computing device 120.

Accordingly, aspects described herein enable enterprise organizations to gain insight into customer experience on a website, application, or the like. By gathering particular information about users, devices, applications, websites, and the like, data may be correlated and analyzed to provide insight for particular users, groups of users, geographic areas, internet service providers, or the like.

Although aspects described herein are described in the context of user telemetry data, the arrangements described may be used to gather, correlated and/or analyze information related to an application itself. For instance, information related to types of error messages occurring inside a workflow, impact of an error on a subset of the population (e.g., within a geographic region or area, associated with an internet service provider, or the like), and the like may be correlated based on the detailed specific information captured via the unique endpoint. This may further enable broad analysis, as well as more granular analysis.

Further, the arrangements described herein may enable not only analysis of data but implementation of remediation processes. For instance, the arrangements described herein may be used to identify trends in errors (e.g., common errors between applications using a same backend technology, common errors with a particular service provider, or the like) and identify and execute a remediation action. For instance, if a particular service provider is having issues in a particular geographic area, an alternative content delivery network may be used to resolve the issues. Various other examples of remediation actions may be used without departing from the invention.

The arrangements described herein provide enterprise organizations with data that may be analyzed to produce various query responses related to what customer or users are doing, issues or problems occurring, and provide an improved customer experience. The arrangements enable capture of various different types of data (e.g., user data, user activity data, user device data, geographic data, browser information, type of device, operating system of device, time of day, and the like) that may be used to provide insight into user activities and needs, as well as identify issues or trends that should be addressed.

For instance, in one example, the captured telemetry data may be analyzed for a particular town using a particular internet service provider to identify issues. If an issue is detected (e.g., an outage or the like) network traffic may be diverted to continue to maintain service for the users within the particular town.

As discussed herein, the generated unique endpoints may be static endpoints having a static string that may be identifiable to the user (e.g., /login) or may be dynamically generated and include a random string of characters. In some examples, a response including the generated endpoint may include a selectable button or other interface element. The selectable button may be associated with a dynamically generated endpoint having a random string of characters because the user is simply provided with a button for selection. However, in arrangements in which a link is provided, a static string may be used enabling the user to recognize or remember the endpoint (e.g., /login).

The generated endpoints may be combined to provide various responses to different users. For instance, a user on the east coast requesting access to a resource may be provided with an endpoint for the east coast version of a login page, while a west coast user may be provided with an endpoint for the west coast login page. Similar arrangements may be provided for different providers, platforms, and the like. Various other examples may be used without departing from the invention.

The arrangements described herein may enable capture or collection of data that might not otherwise be possible with conventional arrangements. For instance, a user may send an email and, in conventional arrangements, might now know if the recipient has clicked on the email or if the email was received. In arrangements described herein, receipt of the email, selection of the email, and the like, may be types of telemetry data captured and provided to telemetry tracking computing platform 110.

Further, the arrangements described herein enable capture of real-time data that provides insight into current conditions and activities. For instance, issues that are currently occurring or errors currently being received may be identified in real-time to improve response time to correct the issues.

As discussed herein, an enterprise organization implementing the arrangements described may customize a storage and/or deletion plan for the captured telemetry data. For instance, each organization may determine how long the data has value or accuracy and may delete the data based on that time period.

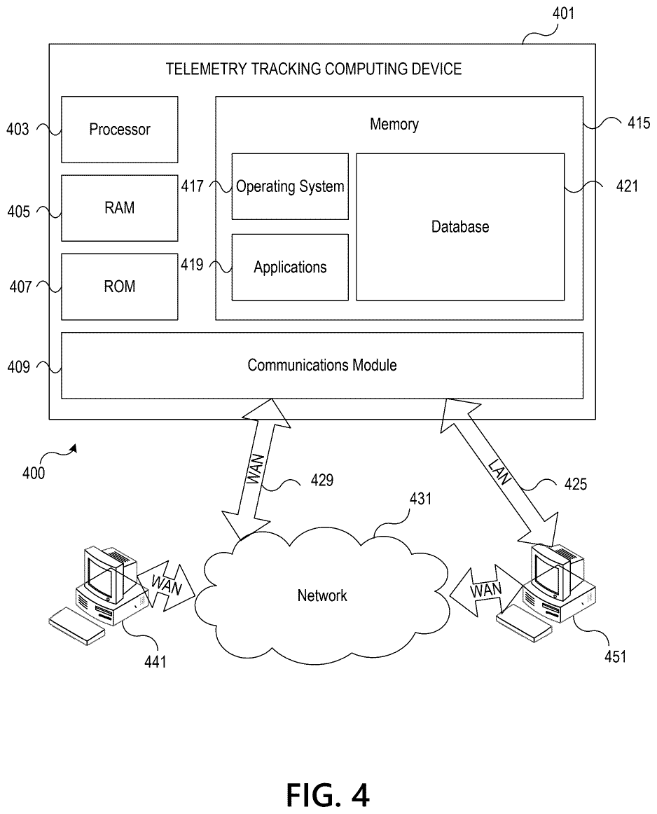

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include telemetry tracking computing device 401 having processor 403 for controlling overall operation of telemetry tracking computing device 401 and its associated components, including Random Access Memory (RAM) 405, Read-Only Memory (ROM) 407, communications module 409, and memory 415. Telemetry tracking computing device 401 may include a variety of computer readable media. Computer readable media may be any available media that may be accessed by telemetry tracking computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by telemetry tracking computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on telemetry tracking computing device 401. Such a processor may execute computer-executable instructions stored on a computer-readable medium.

Software may be stored within memory 415 and/or storage to provide instructions to processor 403 for enabling telemetry tracking computing device 401 to perform various functions as discussed herein. For example, memory 415 may store software used by telemetry tracking computing device 401, such as operating system 417, application programs 419, and associated database 421. Also, some or all of the computer executable instructions for telemetry tracking computing device 401 may be embodied in hardware or firmware. Although not shown, RAM 405 may include one or more applications representing the application data stored in RAM 405 while telemetry tracking computing device 401 is on and corresponding software applications (e.g., software tasks) are running on telemetry tracking computing device 401.

Communications module 409 may include a microphone, keypad, touch screen, and/or stylus through which a user of telemetry tracking computing device 401 may provide input, and may also include one or more of a speaker for providing audio output and a video display device for providing textual, audiovisual and/or graphical output. Computing system environment 400 may also include optical scanners (not shown).

Telemetry tracking computing device 401 may operate in a networked environment supporting connections to one or more remote computing devices, such as computing devices 441 and 451. Computing devices 441 and 451 may be personal computing devices or servers that include any or all of the elements described above relative to telemetry tracking computing device 401.

The network connections depicted in FIG. 4 may include Local Area Network (LAN) 425 and Wide Area Network (WAN) 429, as well as other networks. When used in a LAN networking environment, telemetry tracking computing device 401 may be connected to LAN 425 through a network interface or adapter in communications module 409. When used in a WAN networking environment, telemetry tracking computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive a request to access a resource, wherein the request is received from a user device;
in response to receiving the request, generate a unique endpoint associated with the resource, wherein the unique endpoint includes a uniform resource identifier (URI) and is based on the resource and the user device;
transmit the unique endpoint to the user device;
in response to a user of the user device selecting the unique endpoint:
direct the user device to the resource;
capture telemetry data related to user interactions with the resource; and
store the telemetry data;
receive, from an administrator device, a query, wherein the query includes a request for the telemetry data related to the user interactions with the resource;
generate a query response including the telemetry data related to the user interactions with the resource; and
transmit, to the administrator device, the query response, wherein transmitting the query response causes display of the query response on a display of the administrator device.

2. The computing platform of claim 1, wherein the unique endpoint includes a static string of characters.

3. The computing platform of claim 1, wherein the unique endpoint includes a dynamically generated string of characters.

4. The computing platform of claim 3, wherein the dynamically generated string of characters is generated by executing a machine learning model, wherein executing the machine learning model includes inputting, to the machine learning model, the resource and characteristics of the user device, to output the unique endpoint.

5. The computing platform of claim 4, wherein the characteristics of the user device include an IP address of the user device.

6. The computing platform of claim 1, wherein the telemetry data related to user interactions with the resource includes one or more of: selections made from one or more user interfaces, selections viewed via the one or more user interfaces, a location of the user device, an issue with the resource, a type of device of the user device, or an internet service provider used by the user device.

7. The computing platform of claim 1, wherein the query response includes the telemetry data related to the user interactions with the resource and telemetry data of other user interactions with one of: the resource or one or more other resources.

8. The computing platform of claim 1, further including instructions that, when executed, cause the computing platform to:
determine that a predetermined time period has expired; and
responsive to determining that the predetermined time period has expired, delete the stored telemetry data.

9. The computing platform of claim 1, wherein the resource is one of: a webpage and an application.

10. A method, comprising:
receiving, by a computing platform, the computing platform having at least one processor, and memory, a request to access a resource, wherein the request is received from a user device;
in response to receiving the request, generating, by the at least one processor, a unique endpoint associated with the resource, wherein the unique endpoint includes a uniform resource identifier (URI) and is based on the resource and the user device;
transmitting, by the at least one processor, the unique endpoint to the user device;
in response to a user of the user device selecting the unique endpoint:
directing, by the at least one processor, the user device to the resource;
capturing, by the at least one processor, telemetry data related to user interactions with the resource; and
storing the telemetry data;
receiving, by the at least one processor and from an administrator device, a query, wherein the query includes a request for the telemetry data related to the user interactions with the resource;
generating, by the at least one processor, a query response including the telemetry data related to the user interactions with the resource; and
transmitting, by the at least one processor and to the administrator device, the query response, wherein transmitting the query response causes display of the query response on a display of the administrator device.

11. The method of claim 10, wherein the unique endpoint includes a static string of characters.

12. The method of claim 10, wherein the unique endpoint includes a dynamically generated string of characters.

13. The method of claim 12, wherein the dynamically generated string of characters is generated by executing a machine learning model, wherein executing the machine learning model including inputting, to the machine learning model, the resource and characteristics of the user device, to output the unique endpoint.

14. The method of claim 13, wherein the characteristics of the user device include an IP address of the user device.

15. The method of claim 10, wherein the telemetry data related to user interactions with the resource includes one or more of: selections made from one or more user interfaces, selections viewed via the one or more user interfaces, a location of the user device, an issue with the resource, a type of device of the user device, or an internet service provider used by the user device.

16. The method of claim 10, wherein the query response includes the telemetry data related to the user interactions with the resource and telemetry data of other user interactions with one of: the resource or one or more other resources.

17. The method of claim 10, further including:
determining, by the at least one processor, that a predetermined time period has expired; and
responsive to determining that the predetermined time period has expired, deleting, by the at least one processor, the stored telemetry data.

18. The method of claim 10, wherein the resource is one of: a webpage and an application.

19. One or more non-transitory computer-readable media storing instructions that, when executed by a computing platform comprising at least one processor, memory, and a communication interface, cause the computing platform to:
receive a request to access a resource, wherein the request is received from a user device;
in response to receiving the request, generate a unique endpoint associated with the resource, wherein the unique endpoint includes a uniform resource identifier (URI) and is based on the resource and the user device;
transmit the unique endpoint to the user device;
in response to a user of the user device selecting the unique endpoint:
direct the user device to the resource;
capture telemetry data related to user interactions with the resource; and
store the telemetry data;
receive, from an administrator device, a query, wherein the query includes a request for the telemetry data related to the user interactions with the resource;
generate a query response including the telemetry data related to the user interactions with the resource; and
transmit, to the administrator device, the query response, wherein transmitting the query response causes display of the query response on a display of the administrator device.

20. The one or more non-transitory computer-readable media of claim 19, wherein the unique endpoint includes a dynamically generated string of characters.
